(19) United States
(12) Patent Application Publication
(10) Pub. No.: US 2016/0055448 A1
(43) Pub. Date: Feb. 25, 2016

(54) Method and Apparatus to Provide Centralized Information Database for Retailers, Manufacturers, and Distributors in Target Industries and Markets

(71) Applicant: Stephen K. Ellis, Saratoga, UT (US)

(72) Inventor: Stephen K. Ellis, Saratoga, UT (US)

(21) Appl. No.: 14/467,476

(22) Filed: Aug. 25, 2014

(51) Int. Cl. G06Q 10/08; G06F 17/30

(52) U.S. Cl. CPC G06Q 10/087; G06F 17/30371

(57) ABSTRACT

A method and apparatus for generating and accessing a coded centralized dynamic database via a computer or computer network with the latest product and service information for use by retail establishments, manufacturing facilities, and product distributors.

### RELATED APPLICATIONS

This continuation-in-part patent application claims the benefit of the provisional patent application entitled “Method to Provide Centralized Information Database for Retailers, Manufacturers, and Distributors in Target Industries and Markets”, Ser. No. 61/871,149 filed Aug. 28, 2013

### BACKGROUND OF THE INVENTION

1. Field

This invention pertains to product databases. More particularly, it pertains to a method and apparatus for generating and accessing a coded centralized changing database for use by consumers, retail establishments, manufacturing facilities, and product distributors.

2. State of the Art

Various data sharing systems and methods for selectively sharing data between different users. For example, Warner et al., U.S. Pat. No. 8,505,027 issued Aug. 6, 2013 is directed to a system and method for selectively sharing data between different implementations of the same software program in a network environment. Jerome et al., U.S. Pat. No. 8,495,487 issued Jul. 23, 2013 is an integrated web-based dealership management system providing accounting, financial reporting, parts and service sales tracking, vehicle and parts inventory, vehicle sales tracking, and customer management software developed on a relational database on a web server with web application tools.

A common issue of Point of Sale and Inventory systems is the extreme cost in time and manpower to fully account for a store's inventory. This effort is reproduced by all independent retail/sales companies that may sell from the same product listings available. It may be difficult for manufacturers to be known to all potential sales outlets, and vice versa, reducing the potential sales opportunities for both industry/market entities. The invention described below dramatically reduces the inventory management time and effort, while increasing product, brand, and sales channel awareness.

### BRIEF SUMMARY OF THE INVENTION

The present invention generates a dynamic central database of product information that is primarily populated by industry/market manufacturers/distributors/representatives/etc. with sufficient information inputted into a computer or computer network for access and use by retail stores, outlets, companies, etc. Updates made by these sources would be immediately accessible and usable by retail businesses that use the data. A secondary source of information is inputted into the central database from the retail stores/businesses/etc. and general system users (usually buyers) to add or improve on product information that may or may not yet be in the database. Thus, all product and service information can be sourced into one centralized location for all to use and access, with the appropriate product owners having the primary authority to control data about their products and/or services. Because ideally all product information for all manufacturers and brands would exist in the database, Point of Sale and Inventory systems could rely on this central and current database for proper product and brand identification. This would improve product awareness and information while reducing the input required for otherwise disparate systems to access product information for the purposes of inventory and sales.

The invention comprises a method of generating and providing access to a centralized dynamic database system, which is selectively accessed and sorted by different businesses with different needs, using their own sorting categories. Specifically, it comprises:

i. computer generating a coded centralized independent product/service information database repository containing:

a. coded information regarding Products and Services sold, rented, or traded in different retail industries and regional/global scopes for the purposes of enabling retail data standardization and accessibility,

b. coded images of products,

c. coded prices of product and service information-(examples: MSRP, MRP, MAP, Store Price, Discount Price, Sale Price, Country currency values, etc.),

d. coded private data associated with public data based on account permissions,

ii. removing erroneous or duplicate data from the coded centralized independent product information database repository,

iii. inputting the centralized independent product/service database into a computer or computer network,

iv. providing shared access to the computer or computer network information database repository by different retail establishments, manufacturing facilities and product distributors,

iv. allowing retail establishments, manufacturing facilities and product distributors to selectively sort and download information by indexing sorting codes for selective sorting by various categories.

The centralized product/service inventory database provides isolated and shared access to the information for the purposes of sales that is used by dependent and independent retail outlets and/or companies, and prospective buyers. It also allows manufacturers, distributors, and other sourcing companies to:

a. load product/service information into the database for the purpose of centralized access to product data used by retail outlets and/or companies,

b. load product/service information into the database for the purpose of simplifying inventory management and sales for dependent and independent retail outlets,

c. update and delete product/service information in the database for the purpose of simplifying inventory management and sales for dependent and independent retail outlets and/or companies, and

d. update and delete product/service information in the database for the purpose of centralized access to product data used by retail outlets and/or companies.

This inventory database is also able to provide inventory tracking, sorting, record keeping, etc. for manufacturers, distributors, etc., and not just retail establishments.

In one embodiment, the computer or computer network centralized database of product/service information allows all users to propose additions/updates/deletions of entries from a global and/or private view scope, with an approval and publishing process that is:

a. automated by coded triggers,

b. shared to users to approve, whether individual or multiple people (a social approval system),

c. handled personally by specific account level permissions, and

d. managed by the product manufacturers, distributors or representatives including the benefit of purchase orders and transactional information between stores and manufacturers.

Other standalone versions of the above claimed method and apparatus generating centralized database implementations may be provided for the purpose of offline access to the content to enable sales, inventory management and product lookups.

The database, databases, or central information repository contains all product and service information as it relates to individual and collective markets and industries, and may be categorized by general industrial codes, such as SIC codes.

The database, databases, or central information repository thus provides an electronic Point of Sale and Inventory Management system accessing incorporating the data in a manner accessible to retail outlets/companies, manufacturers, distributors, sales representatives, and other appropriate entities in the supply chain.

Different versions of the database may exist for different industries, markets, companies; there may also be a single database of all information worldwide, interconnected data warehousing of different data types or markets, or any combination of the aforementioned.

For example, the apparatus for generating and providing access to a centralized dynamic database system, which is selectively accessed and sorted by different businesses with different needs, using their own sorting categories, comprises:

A. a coded centralized independent product/service information database repository containing:

i. coded information regarding Products and Services sold, rented, or traded in different retail industries and regional/global scopes for the purposes of enabling retail data standardization and accessibility,

ii. coded images of products, etc.

iii. coded prices of product and service information including MSRP, MRP, MAP, Store Price, Discount Price, Sale Price, Country currency values, and

iv. coded private data associated with public data based on account permissions,

B. a data processor for removing erroneous or duplicate data from the coded centralized independent product information database repository,

C. terminals inputting the centralized independent product/service database into a computer or computer network,

D. processors providing shared access to the computer or computer network information database repository by different retail establishments, manufacturing facilities and product distributors, and

E. terminals allowing retail establishments, manufacturing facilities and product distributors to selectively sort and download information by indexing sorting codes for selective sorting by various categories.

The product database includes bar codes, descriptions, features, specifications, warranties, etc., including who might be selling/distributing/manufacturing it.

The apparatus for generating and providing access to a centralized dynamic database system includes terminals providing isolated and shared access to the database by dependent and independent retail outlets and/or companies, and prospective buyers for the purposes of sales.

It also includes terminals allowing manufacturers, distributors, and other sourcing companies to:

a. load product/service information into the database for the purpose of centralized access to product data used by retail outlets and/or companies,

b. load product/service information into the database for the purpose of simplifying inventory management and sales for dependent and independent retail outlets,

c. update and delete product/service information in the database for the purpose of simplifying inventory management and sales for dependent and independent retail outlets and/or companies, and

d. update and delete product/service information in the database for the purpose of centralized access to product data used by retail outlets and/or companies.

In one embodiment, the apparatus for generating and providing access to a centralized dynamic database system has a computer or computer network accessing the centralized database of product/service information allows all users to propose additions/updates/deletions of entries from a global and/or private view scope, with an approval and publishing process that is:

a. automated by coded triggers,

b. shared via a social approval system for users to approve, whether individual or multiple people,

c. handled personally by specific account level permissions, and

d. managed by the product manufacturers, distributors or representatives including the benefit of purchase orders and transactional information between stores and manufacturers.

The apparatus for generating and providing access to a centralized dynamic database system may include access means providing offline access to the database to enable sales, inventory management and product lookups.

The apparatus for generating and providing access to a centralized dynamic database system may also be adapted so the database, databases, or central information repository contain all product and service information as it relates to individual and collective markets and industries categorized by general industrial codes.

For example, the apparatus for generating and providing access to a centralized dynamic database system may have a database, databases, or central information repository that provides an electronic Point of Sale and Inventory Management system accessing and incorporating data in a manner accessible to retail outlets/companies, manufacturers, distributors, sales representatives, and other appropriate entities in the supply chain.

Thus different versions of the database may exist for different industries, markets, companies; there may also be a single database of all information worldwide, interconnected data warehousing of different data types or markets, or any combination of the aforementioned.

### DESCRIPTION OF THE DRAWINGS

FIG. 1 is a diagram of typical data actors and their connections.

FIG. 2 is a swim lane diagram illustrating the dynamic access and upgrade of the centralized database.

### DESCRIPTION OF THE ILLUSTRATED EMBODIMENTS

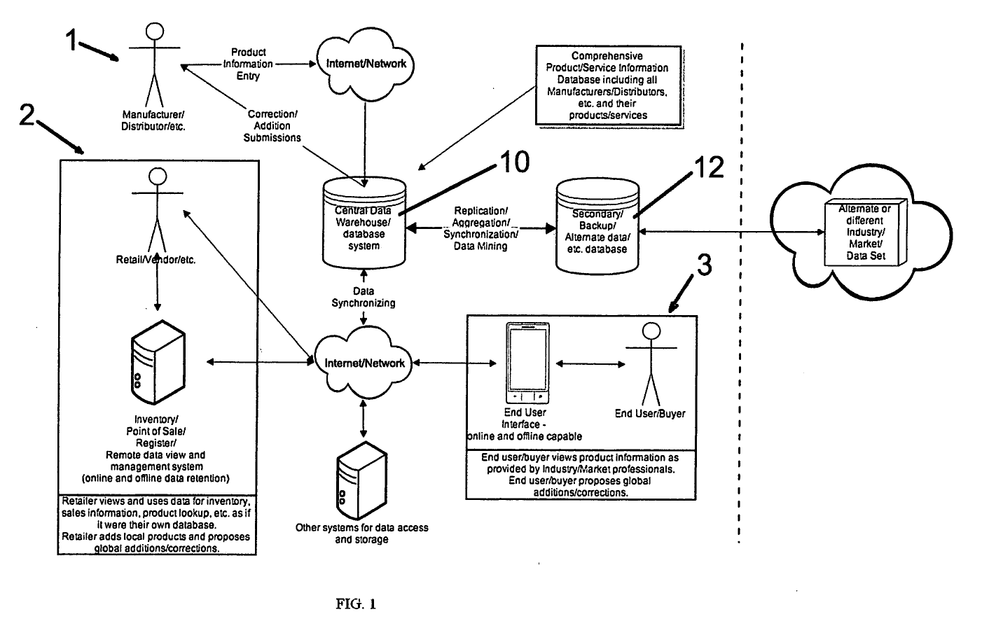

FIG. 1 is a diagram of typical data actors and their connections. Manufacturers 1, retailers/vendors 2, distributors 3 and end users 4 input comprehensive coded product/service data into the centralized database 10 via internet and/or intranet networks. A Secondary Backup 12 is included for securing stored data. The intranet networks may be off-line variations creating a peer-to-peer intranet system than operates similar to the main system behavior, with designated synchronizers for the network. Each device in that intranet could also upload the data individually as well, as the system would recognize a duplicate entry. These internet/intranet networks allow authorized users selective access to sort and retrieve desired information via coding sorts.

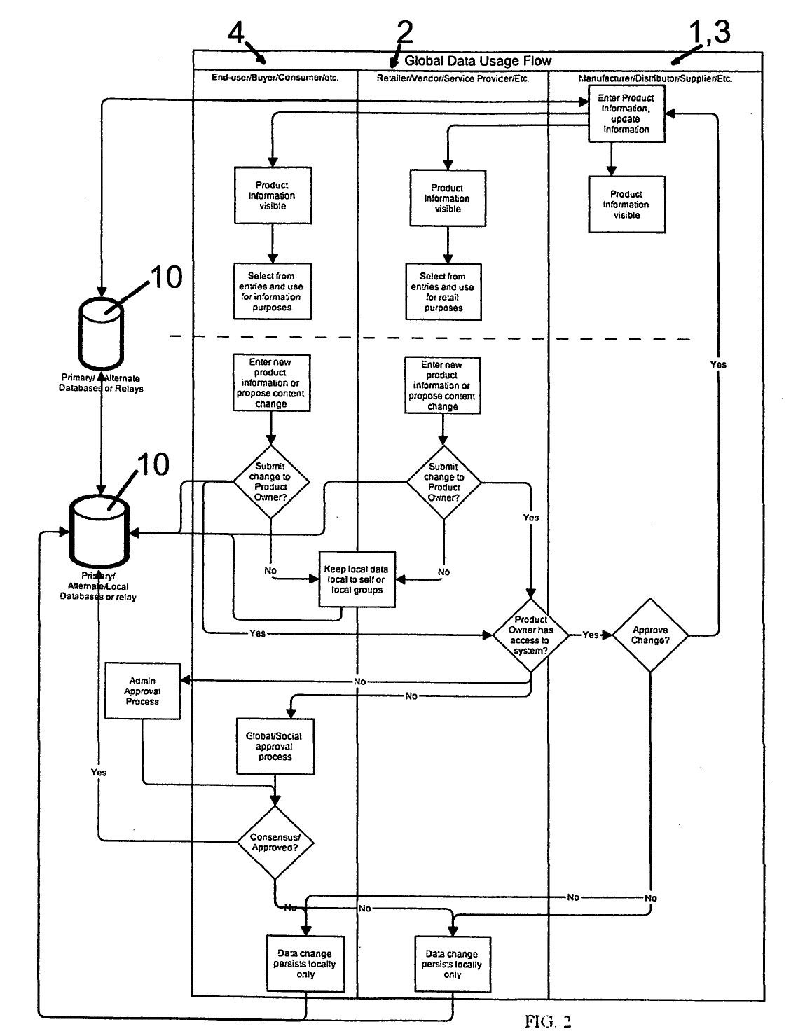

FIG. 2 is a swim lane diagram illustrating an example of the dynamic access and upgrade of the centralized database 10 by manufacturers 1, distributors 3, suppliers 5, and end users 4. These database upgrades may be local for use by a local user 4, or they may be inputted into the central database 10 of universal access.

The present invention thus provides an improved Point of Sale and Inventory system saving the extreme cost in time and manpower to fully account for a store's inventory. This method allows a group of independent retail/sales companies to sell from the same comprehensive product listings available provided by manufacturers to all potential sales outlets, and vice versa, thus increasing potential sales opportunities for both industry/market entities. The invention dramatically reduces the inventory management time and effort, while increasing product, brand, and sales channel awareness via the central database of product information. The central database is created and primarily populated by industry/market manufacturers/distributors/representatives/etc. with sufficient information to provide usability for retail stores, outlets, companies, etc. Updates from these sources are immediately accessible and usable by the retail businesses. Secondary sources of information from the retail stores/businesses/etc. and general system users (usually buyers) may be added to improve upon product information that may or may not yet be in the database. Thus, all product information can be sourced into one location for all to use and access, with the appropriate product owners having the primary authority to control data about their products and/or services. Because ideally all product information for all manufacturers and brands would exist in the database, Point of Sale and Inventory systems could rely on this central and current database for proper product and brand identification. This would improve product awareness and information while reducing the input required for otherwise disparate systems to access product information for the purposes of inventory and sales.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:

1. A method of generating and providing access to a centralized dynamic database system, which is selectively accessed and sorted by different businesses with different needs, using their own sorting categories, comprising:
a. computer generating a coded centralized independent product/service information database repository containing:
i. coded information regarding Products and Services sold, rented, or traded in different retail industries and regional/global scopes for the purposes of enabling retail data standardization and accessibility,
ii. coded images of products,
iii. coded prices of product and service information including one or more of the following: MSRP, MRP, MAP, Store Price, Discount Price, Sale Price, Country currency values,
iv. coded private data associated with public data based on account permissions,
b. removing erroneous or duplicate data from the coded centralized independent product information database repository,
c. inputting the centralized independent product/service database into a computer or computer network,
d. providing shared access to the computer or computer network information database repository by different retail establishments, manufacturing facilities and product distributors, and
e. allowing retail establishments, manufacturing facilities and product distributors to selectively sort and download information by indexing sorting codes for selective sorting by various categories.

2. The method of generating and providing access to a centralized dynamic database system according to claim 2, including providing isolated and shared access to the database by dependent and independent retail outlets and/or companies, and prospective buyers for the purposes of sales.

3. The method of generating and providing access to a centralized dynamic database system according to claim 2, including allowing manufacturers, distributors, and other sourcing companies to:
a. load product/service information into the database for the purpose of centralized access to product data used by retail outlets and/or companies,
b. load product/service information into the database for the purpose of simplifying inventory management and sales for dependent and independent retail outlets,
c. update and delete product/service information in the database for the purpose of simplifying inventory management and sales for dependent and independent retail outlets and/or companies, and
d. update and delete product/service information in the database for the purpose of centralized access to product data used by retail outlets and/or companies.

4. The method of generating and providing access to a centralized dynamic database system according to claim 1, wherein the computer or computer network centralized database of product/service information allows all users to propose additions/updates/deletions of entries from a global and/or private view scope, with an approval and publishing process that is:
a. automated by coded triggers,
b. shared to users to approve, whether individual or multiple people (a social approval system),
c. handled personally by specific account level permissions, and
d. managed by the product manufacturers, distributors or representatives including the benefit of purchase orders and transactional information between stores, manufacturers, distributors, retailers, and consumers.

5. The method of generating and providing access to a centralized dynamic database system according to claim 4, including providing offline access to the database to enable sales, inventory management and product lookups.

6. The method of generating and providing access to a centralized dynamic database system according to claim 1, wherein the database, databases, or central information repository contains all product and service information as it relates to individual and collective markets and industries categorized by general industrial codes.

7. The method of generating and providing access to a centralized dynamic database system according to claim 1, wherein the database, databases, or central information repository provides an electronic Point of Sale and Inventory Management system accessing and incorporating data in a manner accessible to retail outlets/companies, manufacturers, distributors, sales representatives, and other appropriate entities in the supply chain.

8. An apparatus for generating and providing access to a centralized dynamic database system, which is selectively accessed and sorted by different businesses with different needs, using their own sorting categories, comprising:
a. a coded centralized independent product/service information database repository containing:
i. coded information regarding Products and Services sold, rented, or traded in different retail industries and regional/global scopes for the purposes of enabling retail data standardization and accessibility,
ii. coded images of products,
iii. coded prices of product and service information including MSRP, MRP, MAP, Store Price, Discount Price, Sale Price, Country currency values,
iv. coded private data associated with public data based on account permissions,
b. a data processor for removing erroneous or duplicate data from the coded centralized independent product information database repository,
c. terminals inputting the centralized independent product/service database into a computer or computer network, d. processors providing shared access to the computer or computer network information database repository by different retail establishments, manufacturing facilities and product distributors, and
e. terminals allowing retail establishments, manufacturing facilities and product distributors to selectively sort and download information by indexing sorting codes for selective sorting by various categories.

9. The apparatus for generating and providing access to a centralized dynamic database system according to claim 8, including terminals providing isolated and shared access to the database by dependent and independent retail outlets and/or companies, and prospective buyers for the purposes of sales.

10. The apparatus for generating and providing access to a centralized dynamic database system according to claim 9, including terminals allowing manufacturers, distributors, and other sourcing companies to:
a. load product/service information into the database for the purpose of centralized access to product data used by retail outlets and/or companies,
b. load product/service information into the database for the purpose of simplifying inventory management and sales for dependent and independent retail outlets,
c. update and delete product/service information in the database for the purpose of simplifying inventory management and sales for dependent and independent retail outlets and/or companies, and
d. update and delete product/service information in the database for the purpose of centralized access to product data used by retail outlets and/or companies.

11. The apparatus for generating and providing access to a centralized dynamic database system according to claim 8, wherein the computer or computer network accessing the centralized database of product/service information allows all users to propose additions/updates/deletions of entries from a global and/or private view scope, with an approval and publishing process that is:
a. automated by coded triggers,
b. shared via a social approval system for users to approve, whether individual or multiple people,
c. handled personally by specific account level permissions, and
d. managed by the product manufacturers, distributors or representatives including the benefit of purchase orders and transactional information between stores and manufacturers.

12. The apparatus for generating and providing access to a centralized dynamic database system according to claim 11, including access means providing offline access to the database to enable sales, inventory management and product lookups.

13. The apparatus for generating and providing access to a centralized dynamic database system according to claim 8, wherein the database, databases, or central information repository contains all product and service information as it relates to individual and collective markets and industries categorized by general industrial codes.

14. The apparatus for generating and providing access to a centralized dynamic database system according to claim 8, wherein the database, databases, or central information repository provides an electronic Point of Sale and Inventory Management system accessing and incorporating data in a manner accessible to retail outlets/companies, manufacturers, distributors, sales representatives, and other appropriate entities in the supply chain.
